(19) United States
(12) Patent Application Publication
(10) Pub. No.: US 2008/0050284 A1
(43) Pub. Date: Feb. 28, 2008

(54) HOLDING APPARATUS FOR A SAMPLE TO BE TESTED

(76) Inventor: JOHANNES LORSCH, Straelen (DE)

Correspondence Address: Henry M. Feiereisen;Henry M. Feiereisen, LLC, Suite 4714, 350 Fifth Avenue,, New York, NY, 10118, US

(21) Appl. No.: 11/841,320

(22) Filed: Aug. 20, 2007

Related U.S. Application Data
(60) Provisional application No. 60/823,327, filed on Aug. 23, 2006.

(30) Foreign Application Priority Data
Aug. 23, 2006 (DE) 20 2006 012 937.5

(51) Int. Cl. B01L 3/00

(52) U.S. Cl. 422/102

(57) ABSTRACT

Apparatus for holding a sample to be tested includes a flat carrier element for acceptance of a sample, and a covering element. The carrier element is movable in relation to the covering element between a pushed-in position in which the covering element substantially accommodates the carrier element so as to shield the carrier element and the sample from the outside, and a pushed-out position in which the carrier element is moved out of the covering element so as to expose the sample. The carrier element and the covering element are secured to one another by a locking mechanism which includes at least one groove arranged on one member selected from the group consisting of carrier element and the covering element, and a protruding locking member arranged on the other member from the group consisting of carrier element and the covering element and constructed for movement in the groove.

### CROSS-REFERENCES TO RELATED APPLICATIONS

This application claims the benefit of prior filed U.S. provisional Application No. 60/823,327, filed Aug. 23, 2006, pursuant to 35 U.S.C. 119(e), and also claims the priority of German Patent Application, Serial No. 20 2006 012 937.5, filed Aug. 23, 2006, pursuant to 35 U.S.C. 119(a)-(d), the contents of which are incorporated herein by reference in its entirety as if fully set forth herein.

### BACKGROUND OF THE INVENTION

The present invention relates to a holding apparatus for a sample to be tested, such as, e.g., chemical or biological substances or the like.

Nothing in the following discussion of the state of the art is to be construed as an admission of prior art.

Many chemical or biological substances—like e.g. DNA material or BSE test samples—are cryogenically preserved at low temperatures, e.g. stored in liquid nitrogen, so that these substances can be analyzed over an extended period. Typically, the substance is present in liquid or pasty form and applied onto a carrier, e.g. an especially absorbent filter paper. The substance migrates hereby, at least in part, into the carrier and begins to dry to enhance the shelf life. When an analysis is then to be carried out, a small region of the carrier can be punched out or cut out, using a special drill, so as to be able to spot sample small amounts.

It would therefore be desirable and advantageous to provide an improved holding apparatus for samples to be tested, to obviate prior art shortcomings.

### SUMMARY OF THE INVENTION

According to one aspect of the present invention, an apparatus for holding a sample to be tested includes a flat carrier element for acceptance of a sample, a covering element, with the flat carrier element being movable in relation to the covering element between a pushed-in position in which the covering element substantially accommodates the carrier element so as to shield the carrier element and the sample from the outside, and a pushed-out position in which the carrier element is moved out of the covering element so as to expose the sample; and a locking mechanism for securing the carrier element and the covering element to one another, said locking mechanism including at least one groove arranged on one member selected from the group consisting of carrier element and the covering element, and a protruding locking member arranged on the other member from the group consisting of carrier element and the covering element and constructed for movement in the groove.

The present invention resolves prior art problems by providing a secured nested construction between the carrier element and the covering element so as to protect the sample when not in use, as the carrier element is substantially enveloped by the covering element, and allow an automatic handling of the sample for extracting and execution of the analysis. As a result of the locking mechanism, the carrier element can be locked in the covering element without the need for additional parts, whereby the groove and the locking member can be directly molded on, e.g., through injection molding, during production of both elements.

According to another feature of the present invention, the groove and the locking member may be configured to spontaneously implement a locking of the carrier element with the covering element, when the carrier element is pushed initially into the covering element. This simplifies handling of the holding apparatus.

According to another feature of the present invention, the one member may be the carrier element having two side surfaces, each of which being provided with one such groove along a longitudinal side, wherein the other member is then the covering element having two inner side surfaces, each of which being provided with one such locking member on a longitudinal side which is in confronting relationship with the respective longitudinal side of the carrier element. As an alternative, the one member may be the covering element having two inner side surfaces, each of which being provided with one such groove along a longitudinal side, wherein the other member is the carrier element having two side surfaces, each of which being provided with one such locking member on a longitudinal side which is in confronting relationship with the respective longitudinal side of the carrier element. As a result of the locking mechanism, the carrier element is reliably secured in the covering element, and the carrier element and the covering element may each be made of two identical element halves so that the holding apparatus according to the invention requires only two different injection-molded parts in duplicate for complete manufacture. Thus, manufacture of the holding apparatus can be kept simple and production costs can be kept low as result of the small number of parts.

According to another feature of the present invention, the covering element may include at least one slit to render the covering element flexible. Suitably, the slit may be arranged in immediate proximity to the locking member so as to enable a resilient movement of the locking member during initial push-in operation.

According to another feature of the present invention, the covering element may include at least one stop for limiting a push-in length of the carrier element. In other words, the movement of the carrier element into the covering element is limited by the stop.

According to another feature of the present invention, the covering element may include a plurality of openings for engagement of pin-shaped actuator elements for handling the holding apparatus. Suitably, the handling operation is robot-assisted.

According to another feature of the present invention, the covering element may include a lateral cutout for exposing the carrier element to the outside, when the carrier element assumes the pushed-in position.

According to another feature of the present invention, the carrier element may be constructed substantially in the shape of a frame with a central acceptance window for placement of the sample.

According to another feature of the present invention, the carrier element may be comprised of two carrier element halves, each of which having integrated rivets for connection of both carrier element halves with one another. In this way, the use of glue and accompanying risk of contamination of the sample can be avoided.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1a is a schematic plan view of a holding apparatus according to the present invention, depicting a carrier element pushed into a covering element;

FIG. 1b is a schematic side view of the holding apparatus;

FIG. 2a is a schematic plan view of the covering element of the holding apparatus of FIG. 1;

FIG. 2b is a schematic side view of the covering element;

FIG. 3a is a schematic plan view of the carrier element of the holding apparatus of FIG. 1;

FIG. 3b is a schematic side view of the carrier element;

FIG. 4 is a plan view of the holding apparatus of FIG. 1, depicting the carrier element pushed out of the covering element;

FIG. 5a is a side sectional detailed view, on an enlarged scale, of the covering element and the carrier element, depicting the carrier element in a pushed-out position;

FIG. 5b is a side sectional detailed view, on an enlarged scale, of the covering element and the carrier element, depicting the carrier element in a pushed-in position; and

FIG. 6 is a perspective view of the holding apparatus, depicting the carrier element in a pushed-out position.

### DETAILED DESCRIPTION OF PREFERRED EMBODIMENTS

Throughout all the Figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

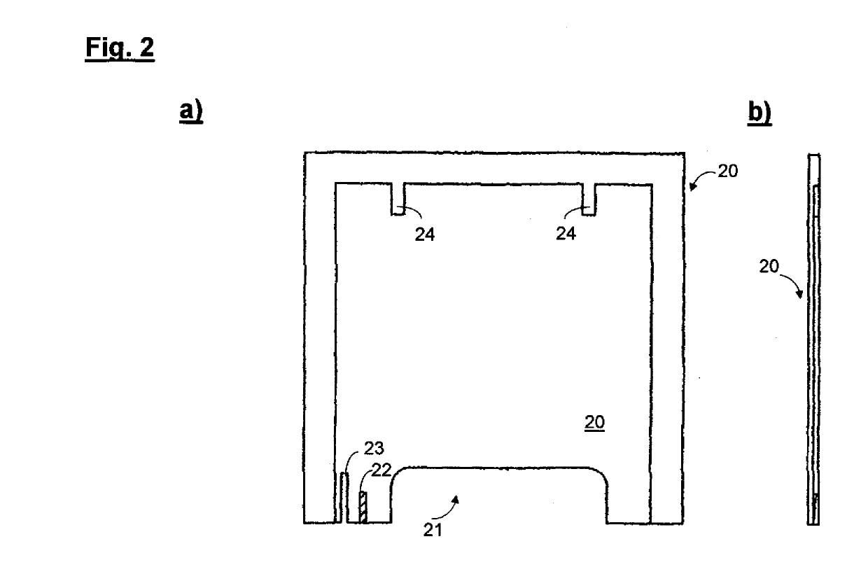

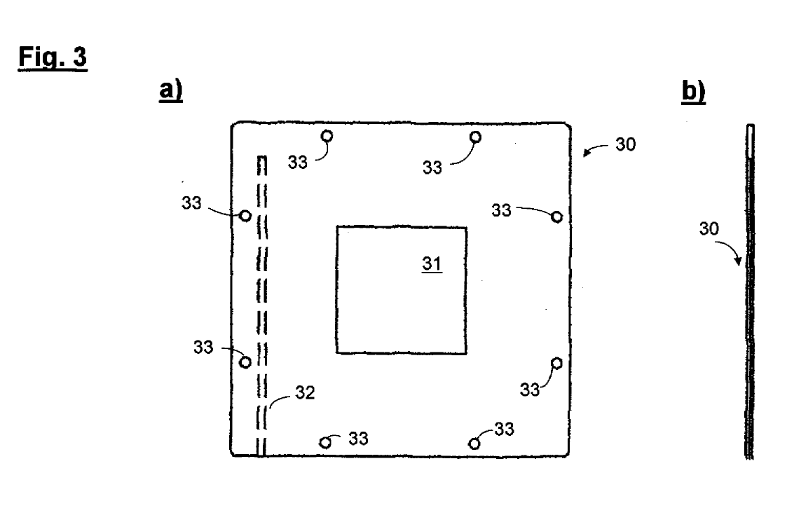

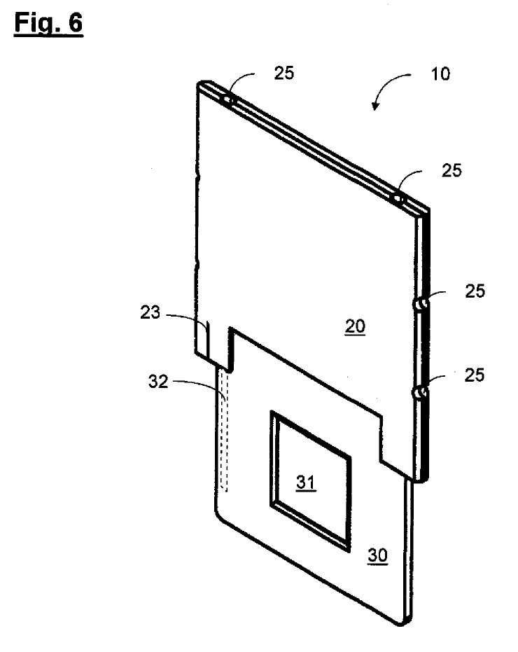

Turning now to the drawing, and in particular to FIG. 6, there is shown a perspective view of a holding apparatus, generally designated by reference numeral 10 and including a flat carrier element 30, shown in detail in FIGS. 3a, 3b, and an enveloping covering element 20, which is shown in detail in FIGS. 2a, 2b and provided to accommodate the carrier element 30 therein. The carrier element 30 is constructed substantially in the form of a frame with a central acceptance window 31 for placement of an unillustrated sample. The sample may hereby be applied on a filter paper. In the non-limiting example, described herein, the carrier element 30 is secured within the covering element 20 by a locking mechanism including two grooves 32 which are arranged on the carrier element 30 on both side surfaces thereof on opposite longitudinal sides and extend along a major portion of the side length of the carrier element 30, and two protruding locking members 22 which respectively interact with the grooves 32. The locking members 22 may be configured in the form of a thickened area or elevation on the adjacent inner side surface of the covering element 20.

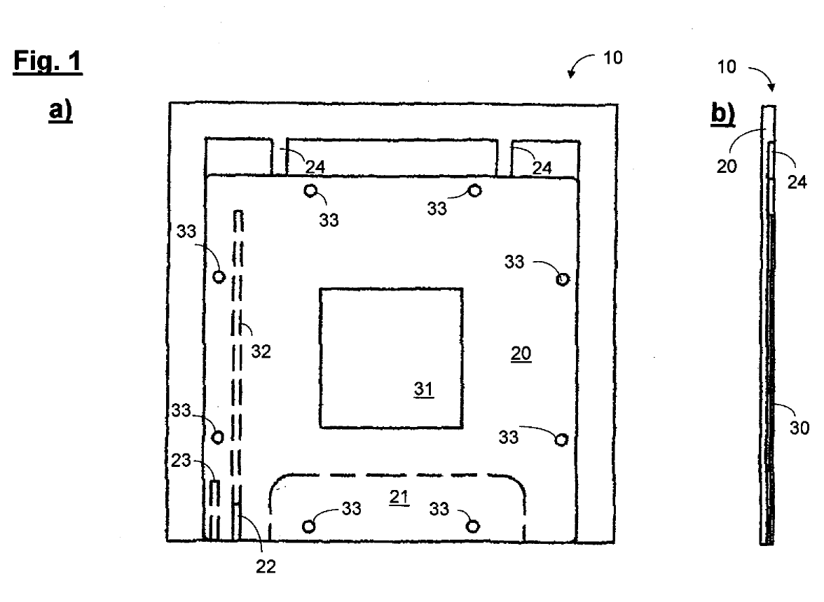

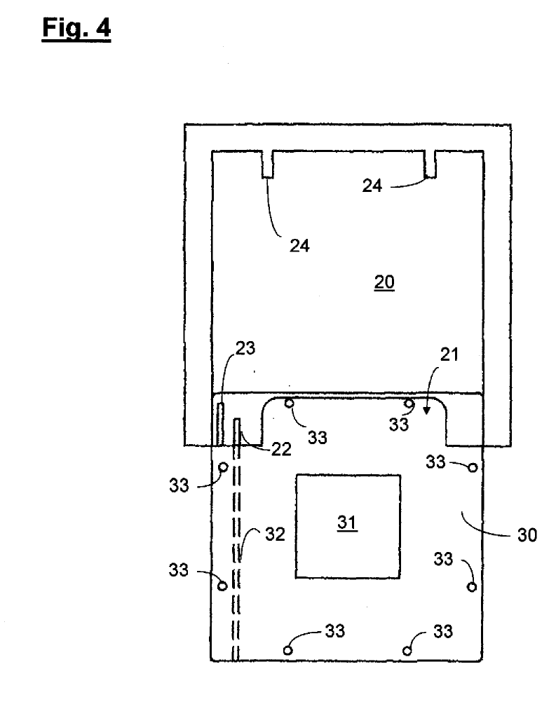

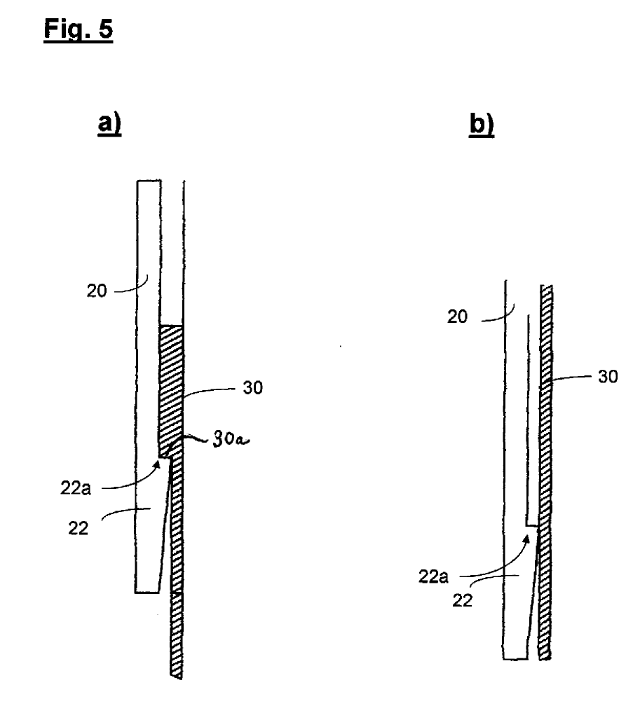

As shown in FIGS. 5a and 5b, the locking member 22 is shaped in the form of a ramp so as to form a tapering section which is arranged on the inside of the covering element 20 and extends in a direction in opposition to a push-in direction of the carrier element 30 and which merges into a step-shaped abutment 22a in push-in direction. Thus, when the carrier element 30 is pushed into the covering element 20 for the first time, the covering element 20 is spontaneously widened until a shoulder 30a of the carrier element 30 hooks behind the abutment 22a of the covering element 20 and the locking member 22 engages within the groove 32. As a result, the carrier element 30 can be moved between a pushed-in position, as shown in FIG. 1a, and a pushed-out position, as shown in FIG. 4, without separation from the covering element 20. The abutment 22a thus forms a barrier for the carrier element 30. The pushed-in position of the carrier element 30 is defined by stops 24 which are molded onto the inside of the covering element 20, as shown in FIGS. 1a, 1b and FIGS. 2a, 2b, and restrict a push-in length of the carrier element 30.

As shown in FIGS. 1a and 2a, the covering element 20 is provided in immediate proximity to the locking member 22 with a slit 23 by which the flexibility of the covering element 20 is enhanced and a resilient movement of the locking member 22 is attained during the initial push-in operation.

As can be seen from a comparison of FIG. 1a and FIG. 4, a sample placed in the acceptance window 31 of the carrier element 30 is fully protected to the outside by the covering element 20, when the carrier element 30 assumes the pushed-in position shown in FIG. 1a, whereas the sample is freely accessible in the pushed-out position shown in FIG. 4 to allow, e.g., a robot-assisted tweezers to grasp the sample. A cutout 21 in a marginal area of the covering element 20 leaves an area of the carrier element 30 exposed to the outside in pushed-in position to thereby permit, optionally, also a manual withdrawal of the carrier element 30 out of the covering element 20.

Currently preferred is a handling of the holding apparatus 10 through the assistance by an unillustrated robot, e.g. by an optional automatic removal of the holding apparatus 10 from a magazine including a plurality of such holding apparatuses. The covering element 20 includes hereby in accordance with FIG. 6 a multiplicity of openings 25 for allowing engagement of pin-shaped actuator elements.

The carrier element 30 is comprised of two carrier element halves, each of which includes integrated riveting means 33, as shown in FIGS. 1a, 3a, by which both carrier element halves can be firmly connected to one another, when the carrier element halves rest flatly upon one another. A carrier for the sample to be accepted and positioned between the two carrier element halves before the latter are riveted together, is automatically secured in this way after complete manufacture of the carrier element 30. There is no need for application of glue so that the risk of contamination of the sample, when using glue, is avoided. Likewise, the enveloping covering element 20 may be made of two identical components. Overall, the holding apparatus 10 according to the invention can thus be effectively made by only two different injection-molded parts in duplicate so that the manufacture can be kept simple and the manufacturing costs can be kept low.

While the invention has been illustrated and described in connection with currently preferred embodiments shown and described in detail, it is not intended to be limited to the details shown since various modifications and structural changes may be made without departing in any way from the spirit of the present invention. For example, the holding apparatus according to the invention may also be applicable for mounting of components such as electronic chips, or the like. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. Apparatus for holding a sample to be tested, comprising:
a flat carrier element for acceptance of a sample;
a covering element, said flat carrier element being movable in relation to the covering element between a pushed-in position in which the covering element substantially accommodates the carrier element so as to shield the carrier element and the sample from the outside, and a pushed-out position in which the carrier element is moved out of the covering element so as to expose the sample; and
a locking mechanism for securing the carrier element and the covering element to one another, said locking mechanism including at least one groove arranged on one member selected from the group consisting of carrier element and the covering element, and a protruding locking member arranged on the other member from the group consisting of carrier element and the covering element and constructed for movement in the groove.

2. The apparatus of claim 1, wherein the sample is a chemical or biological substance.

3. The apparatus of claim 1, wherein the groove is arranged on the inside of the covering element.

4. The apparatus of claim 1, wherein the groove and the locking member are configured to spontaneously implement a locking of the carrier element with the covering element, when the carrier element is pushed initially into the covering element.

5. The apparatus of claim 1, wherein the one member is the carrier element having two side surfaces, each of which being provided with one said groove along a longitudinal side, wherein the other member is the covering element having two inner side surfaces, each of which being provided with one said locking member on a longitudinal side in confronting relationship with the longitudinal side of the carrier element.

6. The apparatus of claim 1, wherein the one member is the covering element having two inner side surfaces, each of which being provided with one said groove along a longitudinal side, wherein the other member is the carrier element having two side surfaces, each of which being provided with one said locking member on a longitudinal side in confronting relationship with the longitudinal side of the carrier element.

7. The apparatus of claim 1, wherein the covering element includes at least one slit to render the covering element flexible.

8. The apparatus of claim 7, wherein the slit is arranged in immediate proximity to the locking member.

9. The apparatus of claim 1, wherein the covering element includes at least one stop for limiting a movement of the carrier element into the covering element.

10. The apparatus of claim 1, wherein the covering element includes a plurality of openings for engagement of pin-shaped actuator elements for handling the apparatus.

11. The apparatus of claim 10, further comprising a robot for assisting the handling of the apparatus.

12. The apparatus of claim 1, wherein the covering element includes a lateral cutout for exposing the carrier element to the outside, when the carrier element assumes the pushed-in position.

13. The apparatus of claim 1, wherein the carrier element is constructed substantially in the shape of a frame with a central acceptance window for placement of the sample.

14. The apparatus of claim 1, wherein the carrier element is comprised of two carrier element halves, each of which having integrated rivets for connection of both carrier element halves with one another.
